(19) United States
(12) Patent Application Publication
(10) Pub. No.: US 2012/0174763 A1
(43) Pub. Date: Jul. 12, 2012

(54) LIGHTWEIGHT ARMOR PROTECTED SHELTERS AND METHODS OF PREPARING SUCH SHELTERS

(75) Inventors: Robert S. Ritchie, Newhall, CA (US); Richard L. Marquez, Sierra Madre, CA (US)

(73) Assignee: Pacific Scientific Energetic Materials Company, Valencia, CA (US)

(21) Appl. No.: 12/564,008

(22) Filed: Sep. 21, 2009

Related U.S. Application Data
(63) Continuation-in-part of application No. 12/360,022, filed on Jan. 26, 2009, now abandoned.
Application No. 12/360,022 is a continuation-in-part of application No. 12/019,607, filed on Jan. 24, 2008, now abandoned.

(51) Int. Cl. F41H 5/24; B23P 17/00; B65B 63/04; F41H 5/06

(52) U.S. Cl. 89/36.04; 89/36.01; 29/428; 53/429; 89/920; 89/918; 89/937

(57) ABSTRACT

Lightweight armor protection systems and methods for armoring a soft-skinned shelter can include a plurality of panel assemblies and a plurality of couplers configured to secure the panel assemblies relative to the soft-skinned shelter. Individual panel assemblies include a plurality of panels positioned adjacent to one another along lengthwise panel edges, wherein the panels are composed of a ballistic material, and a plurality of hinges pivotally coupling the panels. Adjacent individual panels pivot relative to one another between a stacked arrangement of the panel assembly and an expanded arrangement of the panel assembly.

### CROSS-REFERENCE TO RELATED APPLICATION(S)

This patent application is a continuation-in-part of U.S. patent application Ser. No. 12/360,022, filed on Jan. 26, 2009, which is a continuation-in-part of U.S. patent application Ser. No. 12/019,607, filed on Jan. 24, 2008. Both of these related applications are entitled “Lightweight Armor Protection Systems, Transportable Ballistic Shield Systems, and Methods of Using Such Systems” and both are incorporated herein in their entirety by reference.

### TECHNICAL FIELD

The present disclosure relates generally to shelters including lightweight armor protection systems and methods of using such systems to protect or provide a shelter. In particular, the present disclosure relates to lightweight armor protection systems and methods of using such systems for armoring soft-skinned shelters.

### BACKGROUND

Law enforcement and military personnel are commonly exposed to life-threatening injuries during routine and emergency-related response and security assignments. These injuries may be inflicted by bullets, shrapnel, explosions, etc. Conventional bullet-proof and/or protective armor are used regularly by the military and law enforcement for protection during combat and/or other operative duties. For example, bullet proof vests, ballistics shields, etc. can be worn and/or carried for protection against injury. The related patent applications describe systems of using multiple panels of ballistic resistant material to provide protective shields that are light, compact, easily deployed, self supporting and modular, thus providing supplemental protection for personnel, ground vehicles, air vehicles, etc.

Portable, soft-skinned temporary structures, e.g., tents, are also vulnerable to small arms projectiles and fragments from adjacent blasts. The weight of conventional armor, however, makes it impractical for protecting tents and other soft-skinned shelters.

### BRIEF DESCRIPTION OF THE DRAWINGS

FIG. 1A is an isometric view illustrating a first embodiment of a soft-skinned shelter armored with a lightweight armor protection system according to the present disclosure.

FIG. 2 is an isometric view illustrating a second embodiment of a soft-skinned shelter armored with a lightweight armor protection system according to the present disclosure.

FIGS. 3A-3C are isometric views illustrating various embodiments of panel assemblies in expanded arrangements according to the present disclosure.

FIGS. 4A-4C illustrate a first embodiment for pivotally coupling the panels according to the present disclosure.

FIG. 5 illustrates a second embodiment for pivotally coupling the panels according to the present disclosure.

FIGS. 6A-6C are isometric views illustrating stacked arrangements of panel assemblies shown in FIGS. 3A-3C, respectively.

FIGS. 7A-7C are cross-section views illustrating various embodiments of ballistic panels according to the present disclosure.

FIGS. 8A-8C are isometric views illustrating various embodiments of lightweight armor protected shelters according to the present disclosure.

FIG. 9 is an isometric view illustrating a lightweight armor protected wall according to the present disclosure.

FIGS. 10A and 10B illustrate a method of using a lightweight armor protection system to armor a soft-skinned shelter system according to the present disclosure.

### DETAILED DESCRIPTION

### A. Overview

The present disclosure relates generally to shelters including lightweight armor protection systems and methods of using such systems to protect or provide a shelter. One embodiment of a lightweight armor protection system for armoring a soft-skinned shelter can include a plurality of panel assemblies and a plurality of couplers configured to secure the panel assemblies relative to the soft-skinned shelter. Individual panel assemblies include a plurality of panels positioned adjacent to one another along lengthwise panel edges, wherein the panels are composed of a ballistic material, and a plurality of hinges pivotally coupling the panels. Adjacent individual panels pivot relative to one another between a stacked arrangement of the panel assembly and an expanded arrangement of the panel assembly.

Another embodiment of a lightweight armor protection system according to the present disclosure can include, for example, a plurality of panel assemblies and a plurality of couplers configured to couple together the plurality of panel assemblies. Individual panel assemblies include a plurality of panels positioned adjacent to one another along lengthwise panel edges, wherein the panels are composed of a ballistic material, and a plurality of hinges pivotally coupling the panels. Adjacent individual panels pivot relative to one another between a stacked arrangement of the panel assembly and an expanded arrangement of the panel assembly.

A shelter according to an embodiment of the present disclosure can include, for example, a soft-skinned structure configured to be supported on a substrate, a plurality of panel assemblies overlying the soft-skinned structure, and a plurality of couplers configured to couple the plurality of panel assemblies and the soft-skinned structure. Individual panel assemblies include a plurality of panels positioned adjacent to one another along lengthwise panel edges, wherein the panels are composed of a ballistic material, and a plurality of hinges pivotally coupling the panels. Adjacent individual panels pivot relative to one another between a stacked arrangement of the panel assembly and an expanded arrangement of the panel assembly.

A kit configured to assemble a ballistic shelter according to an embodiment of the present disclosure can include, for example, a plurality of ballistic panels, a plurality of hinges pivotally coupling at least two ballistic panels, and a container. Pivotally coupled panels are configured to have a folded arrangement and an unfolded arrangement. The container is configured to store the plurality of ballistic panels and the plurality of hinges in the folded arrangement of the pivotally coupled panels.

A method for armoring a soft-skinned shelter according to an embodiment of the present disclosure can include, for example, assembling a plurality of panel assemblies and folding individual panel assemblies. The plurality of panel assemblies is configured to be portable to the soft-skinned shelter. Each panel assembly includes a plurality of ballistic panels pivotally coupled by a plurality of hinges, and each panel assembly is transported in a stacked arrangement of the plurality of ballistic panels. Individual panel assemblies are folded into the stacked arrangement of the plurality of ballistic panels and are configured to be unfolded to an expanded arrangement.

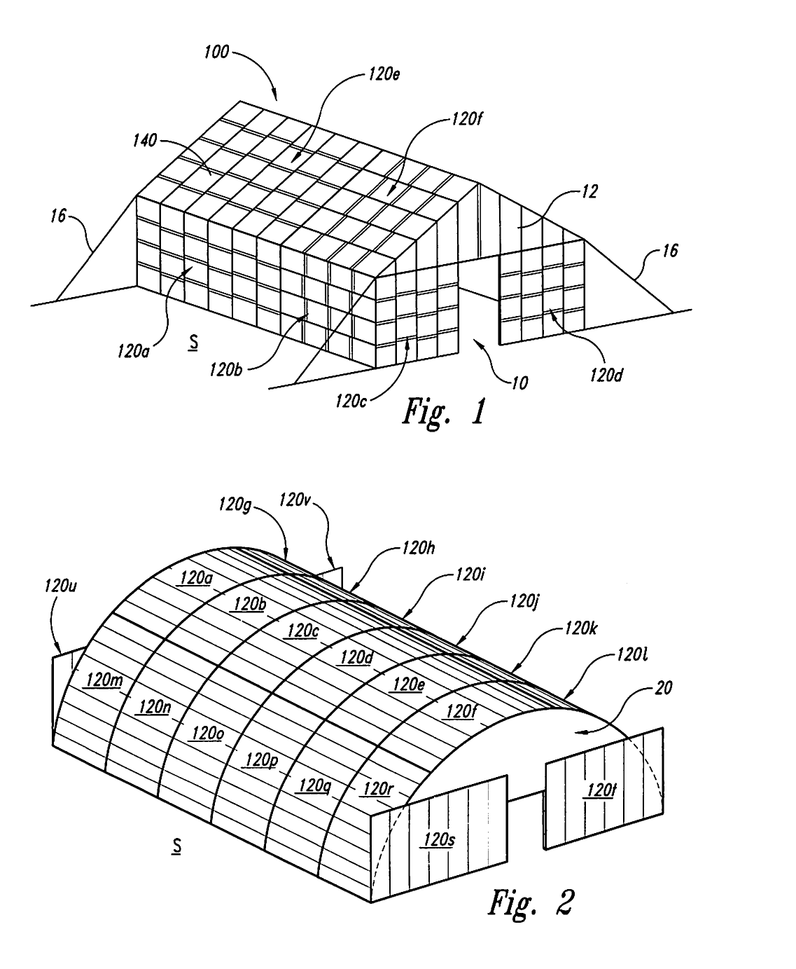

Many specific details of certain embodiments of the disclosure are set forth in the following description and in FIGS. 1A-10B to provide a thorough understanding of these embodiments. A person skilled in the art, however, will understand that the disclosure may be practiced without several of these details or additional details can be added to the invention. Well-known structures and functions have not been shown or described in detail to avoid unnecessarily obscuring the description of the embodiments of the disclosure. Where the context permits, singular or plural terms may also include the plural or singular term, respectively. Moreover, unless the word “or” is expressly limited to mean only a single item exclusive from the other items in reference to a list of two or more items, the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of features are not precluded.

### B. Embodiments of Lightweight Armor Protection Systems for Armoring a Soft-Skinned Shelter

FIG. 1 is an isometric view illustrating a first embodiment of a soft-skinned shelter 10 armored with a lightweight armor protection system (referred to herein as “LAPS”) 100 according to the present disclosure. The soft-skinned shelter 10 may include fabric 12 stretched over a frame (not shown). Guy-wires 16 may be used to stabilize the soft-skinned shelter 10 similar to a conventional tent.

For conventional soft-skinned shelters 10, the LAPS 100 includes a plurality of panel assemblies 120 (panel assemblies 120a-120f are shown in FIG. 1) that can be expanded horizontally, e.g., with individual elongated panels 140 oriented vertically. The panel assemblies 120 can also be expanded vertically, e.g., with the individual elongated panels 140 oriented horizontally. The weight of the panel assemblies 120a-120d, i.e., except for the panel assemblies 120e and 120f that overlie the roof of the soft-skinned shelter 10, is carried by a substrate S, e.g., ground, on which the soft-skinned shelter 10 is located. Accordingly, the panel assemblies 120a-120d contribute lithe or no additional load on the frame of the soft-skinned shelter 10. The panel assemblies 120 can be overlapped or left unfolded if they exceed a dimension of the soft-skinned shelter 10.

FIG. 2 is an isometric view that illustrates a second embodiment of a soft-skinned shelter 20 armored with the lightweight armor protection system 100 according to the present disclosure. The soft-skinned shelter 20 shown in FIG. 2 is an air supported inflatable structure known as a tent extendible modular personnel (TEMPER) structure or any other modular soft shelter that may or may not include an aluminum frame structure. A plurality of panel assemblies 120 (panel assemblies 120a-120r are shown in FIG. 2) overlie the arched portion of the soft-skinned shelter 20 and a plurality of additional panel assemblies 120 (panel assemblies 120s-120v are shown in FIG. 2) cover the ends of the soft-skinned shelter 20. Specifically shaped panel assemblies, not shown, may be used to cover areas of the soft-skinned shelter 20 that are not covered by the panel assemblies 120.

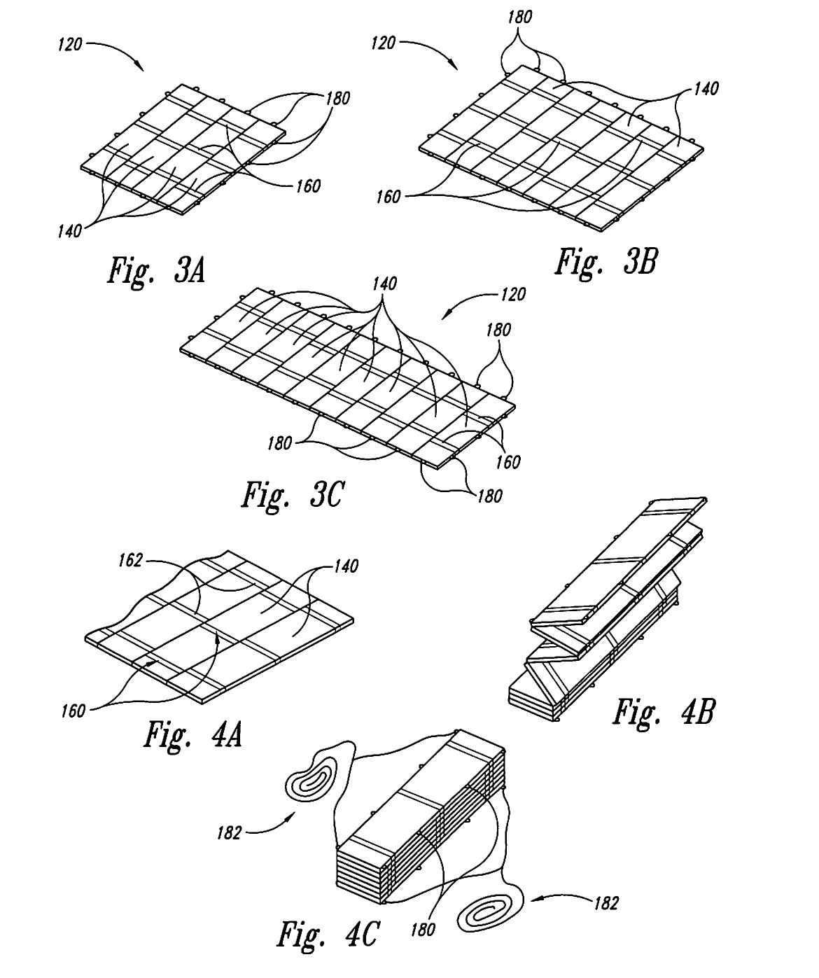

FIGS. 3A-3C are isometric views illustrating various embodiments of panel assemblies 120 in expanded arrangements according to the present disclosure. Each panel assembly 120 includes (a) a plurality of panels 140 positioned adjacent to one another, and (b) a plurality of hinges 160 attached widthwise across the panels 140 to pivotally couple adjacent panels 140. The panel assembly 120 is accordingly configured as an articulated panel wherein the hinges 160 permit relative pivoting between adjacent panels 140.

The panel assemblies 120 can include various numbers of the panels 140 and the panels 140 can have various lengths. For example, FIG. 3A illustrates one embodiment of a panel assembly 120 that includes four panels 140 that are approximately one foot wide by eight feet long. FIG. 3B illustrates another embodiment of a panel assembly 120 that includes seven panels 140 that are approximately one foot wide by eight feet long, and FIG. 3C illustrates yet another embodiment of a panel assembly 120 that includes 12 panels 140 that are approximately one foot wide by four feet long. In other embodiments, the panel assemblies 120 can include a different number of panels 140 (e.g., about 2 panels to about 15 panels, 3 panels, 6 panels, etc.) and the dimensions of the panels 140 can also vary (e.g., approximately 0.5 to 2.5 feet wide and approximately 2 to 12 feet long, etc.).

FIGS. 3A-3C also show that each panel assembly 120 can include a plurality of couplers 180 along the edges of the panel assembly 120. The couplers 180 may include loops, hooks, or other types of attachment points. The couplers 180 may be used to secure the panel assemblies 120 to one another, to the soft-skinned shelter 10 or 20, and/or to the substrate S.

FIGS. 4A-4C illustrate a first embodiment for pivotally coupling the panels 140 according to the present disclosure. The hinges 160 shown in FIGS. 4A-4C include webbing 162 that is interwoven between and around the panels 140 to facilitate folding in either direction. Deployment lines 182, e.g., rope or webbing, may be attached to opposite end panels 140 of each panel assembly 120 to pull the panel assembly 120 over a soft-skinned shelter 10 or 20.

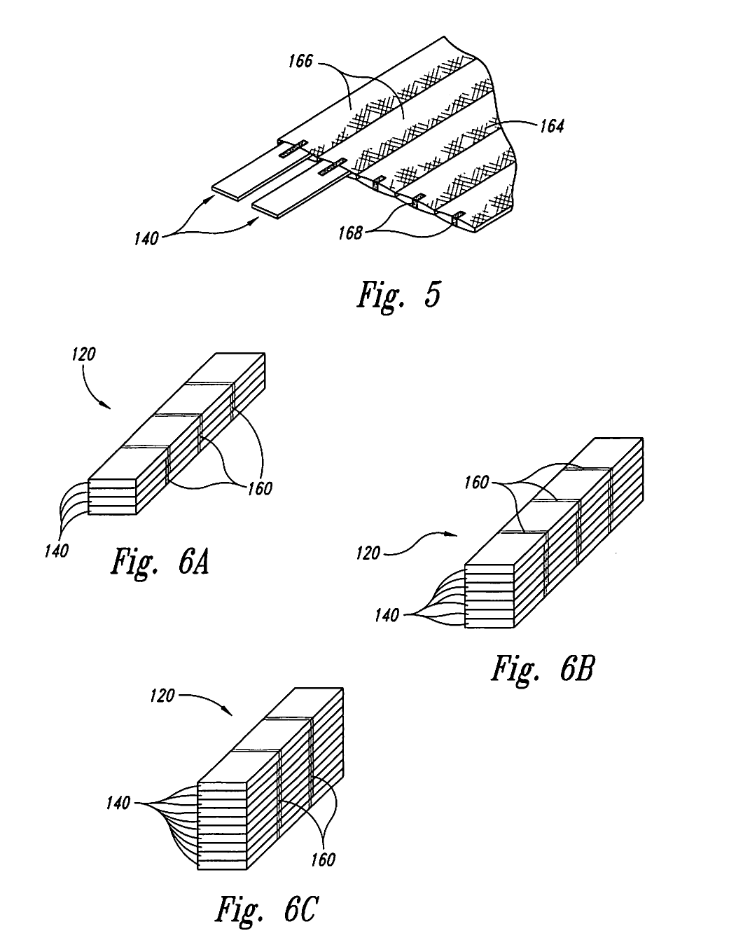

FIG. 5 illustrates a second embodiment for pivotally coupling the panels 140 according to the present disclosure. A lightweight fabric or mesh 164 includes pockets 166 sewn lengthwise. A panel 140 is inserted in each pocket 166 and the pocket can be held closed, e.g., with hook and loop fastening straps 168. Accordingly, different panels 140 or multiple panels 140 can be inserted into individual pockets 166 for additional ballistic protection without modification to the packaging and deployment.

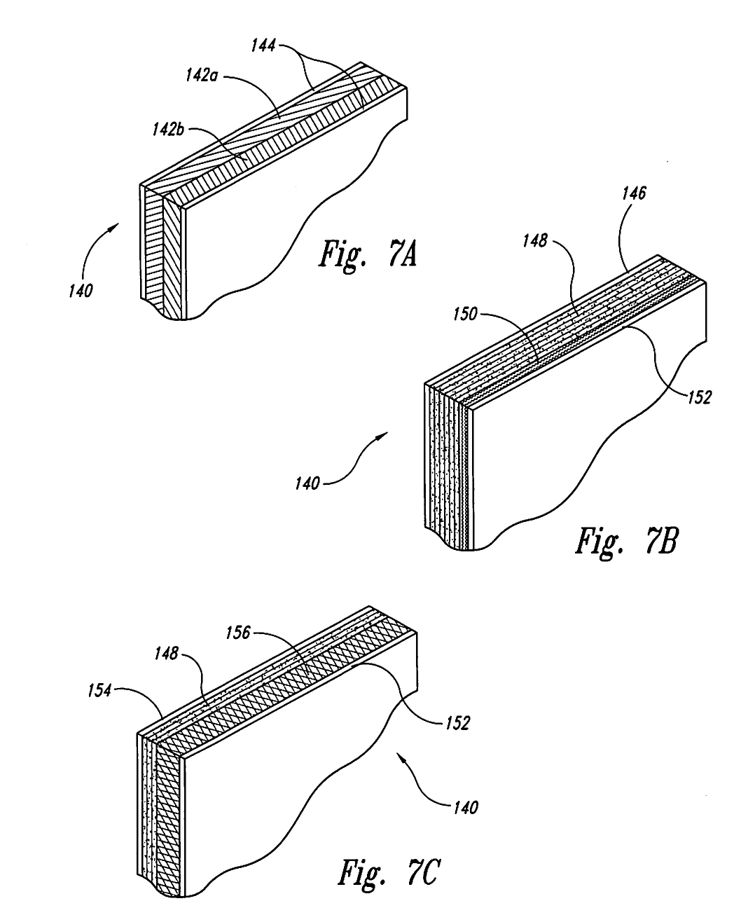

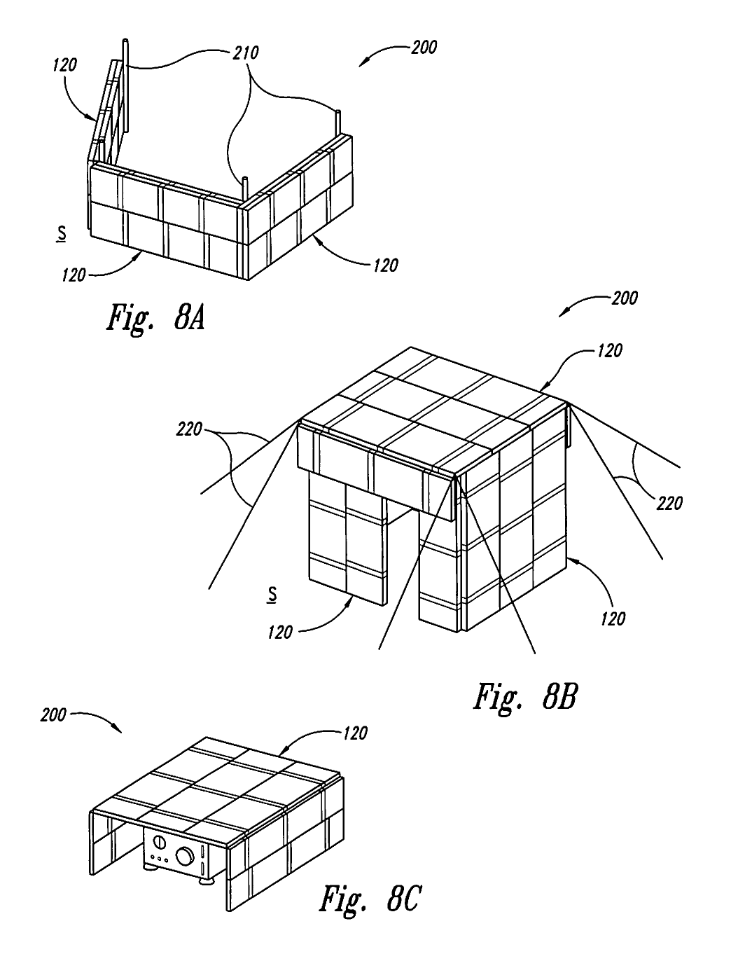

FIGS. 6A-6C are isometric views illustrating stacked arrangements of panel assemblies shown in FIGS. 3A-3C, respectively. Accordingly, FIG. 6A illustrates the stacked arrangement of the panel assembly 120 shown in FIG. 3A including four panels 140 arranged in a stack approximately one foot wide by eight feet long by four inches high. FIG. 6B illustrates the stacked arrangement of the panel assembly 120 shown in FIG. 3B including seven panels 140 that are approximately one foot wide by eight feet long by seven inches high, and FIG. 6C illustrates the stacked arrangement of the panel assembly 120 shown in FIG. 3C including 12 panels 140 that are approximately one foot wide by four feet long by 12 inches high.

FIGS. 7A-7C are cross-section views illustrating various embodiments of ballistic panels 140 according to the present disclosure. The panels 140 provide individual rigidity to absorb the kinetic energy from the impact of a projectile. FIG. 7A illustrates a layered panel 140 including different composite layers 142a and 142b sandwiched between layers of a soft coating 144. FIG. 7B illustrates another embodiment of a panel 140 that includes a hard coating 146, a layer of ballistic fiber 148, a wire mesh layer 150, and a rigid backing layer 152. The rigid backing layer 152 may be painted with a camouflage color and pattern and/or include a flame retardant coating or another environmental coating. Accordingly, the panels 140 can be fire and/or heat resistant for providing protection against explosions. FIG. 7C illustrates yet another embodiment of a panel 140 that includes a carbonate sheet 154, one or more layers of ballistic fiber(s) 148, a layer of filled metal foam 156, and a rigid backing layer 152. Each panel 140 may have a thickness of less than 0.25 to approximately 1.0 inch and weigh approximately 0.50 to 2.0 pounds/square foot.

The panels 140 can be structurally rigid and be composed of ballistics materials that generally are designed to resist penetration by bullets and other ballistic projectiles. Examples of ballistic materials include rigid, lightweight composite materials (e.g., high-density plastic, steel, aluminum, resin composite material, titanium, etc.) and/or composite woven fiber materials such as KEVLAR® (a light, strong para-aramid synthetic fiber, with high strength-to-weight ratio), VECTRAN® (an aromatic polyester fiber noted for thermal stability at high temperatures, high strength and modulus, low creep, chemical stability, and moisture resistance), DYNEEMA® (a strong polyethylene fiber with high strength-to-weight ratio that is resistant to moisture, UV light and chemicals), and/or various fiberglass compositions. In other embodiments the panels 140 can be composed of a monolithic material or mixture of materials.

The composition of the panels 140 may be selected based on the ballistic requirements and may include a composite woven fiber material or combination of ballistic materials including. In one embodiment, the ballistics material can include material for providing United States National Institute of Justice (NIJ) Level III ballistic protection. NIJ Level III is classified as armor that at least protects against 7.62 mm full metal jacketed bullets with nominal masses of 9.6 grams (147 grains) that impact the material at a velocity of 847±9.1 meters/second (2780±30 feet/second). Other standards promulgated by NIJ include Level III-A and Level II ballistic protection for body armor. NIJ Level III-A is classified as armor that at least protects against 0.357 SIG full metal jacketed bullets with nominal masses of 8.1 grams (125 grains) that impact the material at a velocity of 448±9.1 meters/second (1470±30 feet/second). NIJ Level II is classified as armor that at least protects against 9 mm full metal jacketed bullets with nominal masses of 8.0 grams (124 grains) that impact the material at a velocity of 398±9.1 meters/second (1305±30 feet/second). One of ordinary skill in the art will recognize a variety of suitable materials that can be used to form the panels 140. Moreover, the skilled artisan will recognize that the ballistics material used to form the panels 140 can be rated at varying levels of armor protection and/or have other protective characteristics.

In some embodiments, the layers of the panels 140 may also be inversely repeated so that there is no difference in the layers front-to-back and back-to-front. Accordingly, the panel assemblies 120 may be deployed without a preference as to whether the front or back surface is initially impacted by a projectile.

### C. Embodiments of Lightweight Armor Protected Shelters

FIGS. 8A-8C are isometric views illustrating various embodiments of lightweight armor protected shelters 200 according to the present disclosure. The panel assemblies 120 can be partially expanded, conform to curved surfaces, be overlapped and/or used individually or in combination as a stand alone structure. FIG. 8A illustrates three panel assemblies 120 configured as a stockade and secured together by the couplers 160 and stakes 210 driven into the substrate S. Each of the panel assemblies 120 shown in FIG. 8A is partially expanded such that it overlaps itself to increase ballistic resistance and provide additional protection against a threat from a specific direction(s). FIG. 8B illustrates a combination of panel assemblies 120 configured as a room with a door and a roof. FIG. 8B also shows guy-wires 220 to stabilize the combination of panel assemblies 120. FIG. 8C illustrates a single panel assembly 120 configured to provide overhead protection to cover, for example, sensitive or critical equipment or materials without a supporting structure.

### C. Embodiments of Lightweight Armor Protection within Shelters

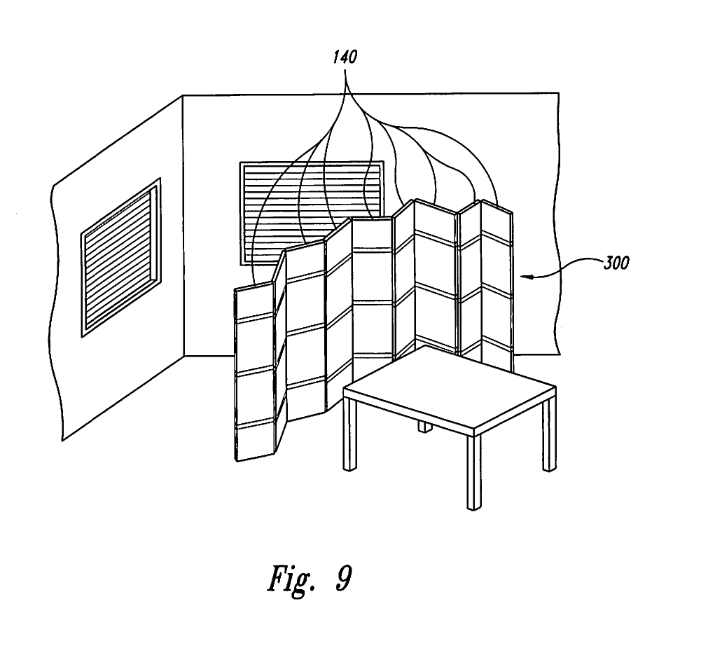

FIG. 9 is an isometric view illustrating a lightweight armor protected wall 300 according to the present disclosure. The wall 300 may provide additional ballistic protection on the interior of existing buildings or shelters. The panels 140 of the wall 300 can be vertically orientated and partially folded so as to be free standing and portable. In other embodiments, the wall 300 may be attached to existing walls, doors, windows to provide protection from vulnerable directions.

### D. Embodiments of Methods for Armoring a Soft-Skinned Shelter with Lightweight Armor Protection Systems

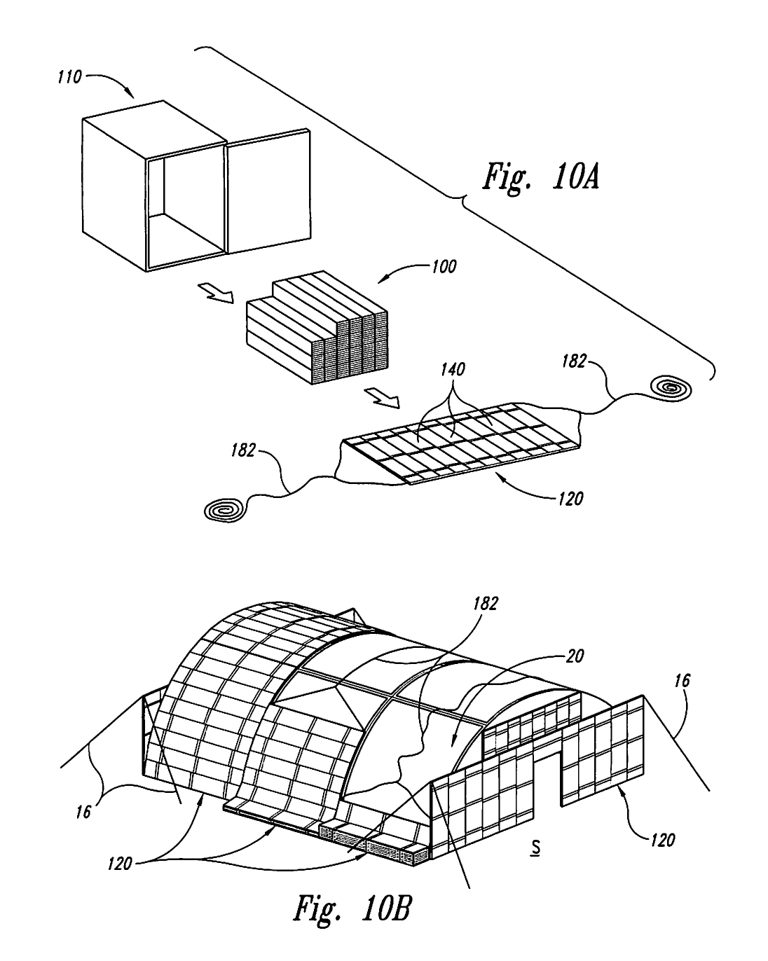

FIGS. 10A and 10B illustrate a method of using a lightweight armor protection system (LAPS) 100 to armor a soft-skinned shelter according to the present disclosure. For example, FIG. 10B shows a TEMPER air supported inflatable shelter 20 that is 22 feet in diameter and 32 feet long. Accordingly, the exterior surface area is 1486 square feet.

As shown in FIG. 10A, the LAPS 100 may be transported in a conventional standardized transportation container 110 (e.g., TRICON, Type I, Dry Freight Container with an internal volume of 7 feet by 7 feet by 6 feet or 294 cubic feet). The minimum dimension in the container 110 determines the maximum length panel length, e.g., six feet, so 248 linear feet of one foot wide panels are required. The distance over the top of the shelter is 34.5 feet and in order to minimize the number of panel assemblies 120, panel assemblies 120 that include 11 panels 140 that are six feet long by one foot wide are selected for covering the arch. Such a panel assembly 120 can be reasonably handled because, if the panels weight approximately 1.5 lb per square foot, each panel assembly 120 will weigh approximately 99 pounds, which is under a 112 pound limit determined for an individual component. To cover the entire shelter 20, 22 panel assemblies 120 including 242 panels 140 are selected. If thickness of the panel assemblies 120 in a stacked arrangement is approximately 0.5 feet then the volume of each panel assembly 120 is approximately 3 cubic feet. Thus, the total volume of 22 panel assemblies 120 is approximately 66 cubic feet, which is under the volume of the container 110. According to this embodiment, three LAPS 100 will fit in a single container 110. The container 110 can therefore also include spare lines, panels, and/or a repair kit.

For the shelter 20 shown in FIG. 10B, the deployment lines 182 coupled to the panel assemblies 120 may be used to pulled the panel assemblies 120 up and over the shelter 20 with the panels 140 orientated horizontally, e.g., to conform to the curved surface of the shelter 20. FIG. 10B illustrates the shelter 20 at various stages of deploying the LAPS 100.

The panel assemblies 120 are removed from the container 110 and positioned around the bottom of the shelter 20. The deployment lines 182 are passed over to the opposite side of the shelter 20 and pulled from the opposite side so as to expand, e.g., unfold, and deploy the panel assembly 120. The container 110 may additionally contain illustrated instructions (not shown), spare couplers 180, spare deployment lines 182, and/or a repair kit (not shown). In some embodiments, specific shelters may include odd shaped areas that are not covered by the standard panel assemblies 120. Accordingly, specifically shaped panel assemblies (not shown) can also be included in the container 110.

Referring to FIG. 8B, the center panel assembly 120 may be secured before deploying the side panel assemblies 120 to either side of an individual center panel assembly 120. The deployment lines 182 can be secured to stakes in the substrate S. The panel assemblies 120 can overlap at the sides and/or ends of the shelter 20. Panel assemblies 120 may be deployed in a vertical orientation at the ends of the shelter 20. These end panel assemblies 120 can be attached with the couplers 180 to the shelter 20 or stabilized with guy-wires 16. Insofar as any of the panel assemblies 120 can be deployed anywhere on the shelter 20, no time is wasted identifying, orienting and/or locating particular panel assemblies 120.

Disassembling the LAPS 100 may be performed in generally the reverse order. For example, the end panel assemblies 120 can be folded into their stacked arrangement, followed by the side panel assemblies 120 and then the center panel assemblies 120. Since all panel assemblies 1210 are identical, no special stowage order is required for the container 110.

Repairing the LAPS 100 in the field may be necessary if (1) penetration or deformation of a single projectile interferes with deployment or stowage of the panel assembly and/or (2) there is damage to the attachments or an individual panel replacement. Small punctures or protrusions in the panels 140 that include a fiber composite can be repaired according to conventional fiberglass repair techniques. Accordingly, a repair kit (not shown) may include fabric patches, resin, catalyst and mixing container. The surface of the panel 140 to be repaired may initially be cleaned and smoothed. Several layers of patches and the mixed resin and catalyst may be applied over the damaged area and allowed to cure. Further finishing the repaired surface is optional.

Replacing a whole panel 140 can be easily accomplished by cutting the attaching webbing 160, inserting a replacement panel 140, and re-bonding the webbing 160 to the adjacent panels 140. The webbing 160 can be re-bonded to the panels 140 without precision. The container 110 may also contain one or more replacement panels 140 and webbing 160 for field assembling a specialty panel. If the panels 140 are located in fabric or mesh pockets 166, the panels 140 can be removed and replaced easily.

### D. Exemplary Features and Advantages of Lightweight Armor Protection Systems for Armoring Soft-skinned Shelters

Recent war-time conflicts have identified a vulnerability of soldiers to ballistic attacks. The exposure can increase when soldiers must dismount from armored or unarmored vehicles, or for soldiers positioned in the rear of unarmored trucks. Soldiers can also be exposed to ballistic threats at outposts, check points or during a direct assault. Similar exposure can be experienced by law enforcement personnel and SWAT teams during their job-related duties. Navy and the Coast Guard personnel can have potentially the same vulnerability in water vessels when patrolling and intercepting enemy boats and ships.

Protection from the threat of small arms such as 7.62 mm ammunition and shrapnel from near-by exploded ordnance is needed by a variety of military and law enforcement officers. Current armor systems having protection at ballistic NIJ Level III and above are typically heavy armor plates that are permanently installed panels. Individual shields with this level of protection are typically heavy, cumbersome and require a user to hold and support the shield, which can significantly inhibit the user's offensive capability (e.g., perform other tasks requiring two hands, aim and fire a firearm, etc.).

In contrast, use of the LAPS 100 disclosed herein can provide soldiers and other law enforcement personal with portable shelters that can be quickly and easily stowed, rapidly deployed, and re-positioned as needed. The use of the lightweight, rigid composite materials disclosed herein can provide ballistic protection with approximately half the weight of conventional panels of the same size and protection level. Composites, ceramics, fabrics and combinations provide ballistic protection at a fraction of the weight of conventional metal armor.

Advantages of the LAPS 100 include panel assemblies 120 of ballistic plates 140 connected by hinges 160 that are configured to fold into a compact size for stowage. The panel assemblies 120 may include panels 140, hinges 160, couplings 180 and deployment lines 182 that can be removed and/or replaced if they become damaged, thereby enhancing the longevity and protection level of the assembly.

Other advantages of the LAPS 100 include panel assemblies that can be deployed as a free standing stockade, room and/or cover that is easily and quickly re-configured to respond to the nature and direction of a threat. Another advantage of the LAPS 100 is providing added ballistic protection for temporary, soft sided structures including; command centers, sleeping quarters, medical facilities, food preparation serving, interiors of meeting rooms and protection of sensitive equipment.

The LAPS 100 includes a series of individual panels 140, which when attached with the hinges 160; provide a high level of ballistic protection that is easily erected to armor temporary structures without adding excessive weight. Additionally, the LAPS 100 can be deployed quickly with simple deployment methods and without extensive training or special equipment.

According to some embodiments, the panels 140 can also include environmental protection, flammability resistance, projectile or fragment break-up, absorption of kinetic energy, and some level of rigidity. Providing rigidity assists in distributing impact loading over the entire area of the panels 140.

The individual panel assemblies 120 can be combined and coupled to provide protection to a larger total area and provide different levels of ballistic protection depending on the intended installation. The panels 140 also can be deployed in either horizontal or vertical orientations and partially deployed, e.g., to conform to curved surfaces. The panel assemblies 120 can also be overlapped or layered if additional protection is required due to a threat from a specific direction, or can be used to cover sensitive or critical equipment or materials without a supporting structure.

The LAPS 100 can be used to erect an emergency protective shelter without an underlying structure. For example, side panel assemblies 120 can be erected with the panels 140 vertically orientated with or without guys, and can also provide a roof covering. Such an emergency protective shelter can be used for ambush protection, medical treatment or temporary protection from nearby small arm fire and exploding munitions.

Deploying the LAPS 100 may be accomplished without prior training and does not require any special equipment. Further, the LAPS 100 may be transported in conventional, standardized containers.

From the foregoing, it will be appreciated that specific embodiments of the disclosure have been described herein for purposes of illustration, but that various modifications can be made without deviating from the spirit and scope of the disclosure. For example, although many of the embodiments are described herein with respect to lightweight armor protection systems, or other types of transportable shield systems (e.g., hand-held shields, hanging shields, firearm and/or other military training shields, fire and/or heat shields, etc.) may be within the scope of the disclosure. Moreover, specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the invention. Accordingly, embodiments of the disclosure are not limited except as by the appended claims.

I/we claim:

1. A lightweight armor protection system for armoring a soft-skinned shelter, the system comprising:
a plurality of panel assemblies, wherein individual panel assemblies include—
a plurality of panels positioned adjacent to one another along lengthwise panel edges, wherein the panels are composed of a ballistic material; and
a plurality of hinges pivotally coupling the panels, wherein adjacent individual panels pivot relative to one another between a stacked arrangement of the panel assembly and an expanded arrangement of the panel assembly; and
a plurality of couplers configured to secure the panel assemblies relative to the soft-skinned shelter.

2. The system of claim 1 wherein the plurality of couplers comprises a plurality of deployment lines, and individual deployment lines are coupled to individual panel assemblies and are configured to position the individual panel assembly with respect to the soft-skinned shelter.

3. The system of claim 1 wherein the plurality of couplers are configured to couple together individual panel assemblies.

4. The system of claim 3 wherein the plurality of couplers comprises a plurality of loops, and individual loops are fixed to individual panel assemblies.

5. The system of claim 1 further comprising a plurality of deployment lines, wherein individual deployment lines are coupled to individual panel assemblies and are configured to deploy the individual panel assemblies from the stacked arrangement to the expanded arrangement.

6. The system of claim 5 wherein individual deployment lines are configured to position the individual panel assemblies with respect to the soft-skinned shelter.

7. A lightweight armor protection system, the system comprising:
a plurality of panel assemblies, wherein individual panel assemblies include—
a plurality of panels positioned adjacent to one another along lengthwise panel edges, wherein the panels are composed of a ballistic material; and
a plurality of hinges pivotally coupling the panels, wherein adjacent individual panels pivot relative to one another between a stacked arrangement of the panel assembly and an expanded arrangement of the panel assembly; and
a plurality of couplers configured to couple together the plurality of panel assemblies.

8. The system of claim 7 wherein the plurality of couplers comprises a stake configured to fix the plurality of panel assemblies relative to a substrate supporting the plurality of panel assemblies.

9. The system of claim 7 further comprising a plurality of guy-wires configured to stabilize the plurality of panel assemblies relative to a substrate supporting the plurality of panel assemblies.

10. A shelter, comprising:
a soft-skinned structure configured to be supported on a substrate;
a plurality of panel assemblies overlying the soft-skinned structure, wherein individual panel assemblies include—
a plurality of panels positioned adjacent to one another along lengthwise panel edges, wherein the panels are composed of a ballistic material; and
a plurality of hinges pivotally coupling the panels, wherein adjacent individual panels pivot relative to one another between a stacked arrangement of the panel assembly and an expanded arrangement of the panel assembly; and
a plurality of couplers configured to couple the plurality of panel assemblies and the soft-skinned structure.

11. The shelter of claim 10 further comprising a plurality of deployment lines configured for deploying the panel assemblies from the stacked arrangement to the expanded arrangement, wherein individual deployment lines are coupled to individual panel assemblies and overlie the soft-skinned structure during deploying the panel assemblies.

12. The shelter of claim 10 wherein the soft-skinned structure comprises fabric supported on a frame.

13. The shelter of claim 10 wherein the soft-skinned structure comprises a fabric envelope configured to be inflated.

14. The shelter of claim 10 wherein the plurality of couplers comprises a plurality of fabric pockets.

15. The shelter of claim 14 wherein individual fabric pockets are configured to receive individual panels.

16. The shelter of claim 14 wherein the soft-skinned structure comprises the individual fabric pockets.

17. A kit configured to assemble a ballistic shelter, comprising:
a plurality of ballistic panels;
a plurality of hinges pivotally coupling at least two ballistic panels, wherein the pivotally coupled ballistic panels are configured to have a folded arrangement and an unfolded arrangement; and
a container configured to store the plurality of ballistic panels and the plurality of hinges in the folded arrangement of the pivotally coupled panels.

18. The kit of claim 17, further comprising a soft-skinned structure, wherein the pivotally coupled panels overlie the soft-skinned structure in the unfolded arrangement of the pivotally coupled panels.

19. The kit of claim 18 wherein the soft-skinned structure comprises a tent or an inflated structure.

20. The kit of claim 17, further comprising attachments configured to attach sets of pivotally coupled panels.

21. The kit of claim 17, further comprising deployments configured for deploying the pivotally coupled ballistic panels from the folded arrangement to the unfolded arrangement.

22. The kit of claim 17 wherein the ballistic panels comprise at least one of woven ballistic fiber, wire mesh, a rigid backing layer, and a fire resistant coating.

23. The kit of claim 17 wherein the hinges comprise webbing interwoven between and around adjacent ballistic panels.

24. A method for armoring a soft-skinned shelter, the method comprising:
assembling a plurality of panel assemblies configured to be portable to the soft-skinned shelter, wherein each panel assembly includes a plurality of ballistic panels pivotally coupled by a plurality of hinges, and each panel assembly is portable in a stacked arrangement of the plurality of ballistic panels; and
folding individual panel assemblies into the stacked arrangement of the plurality of ballistic panels, wherein individual panel assemblies are configured to be unfolded to an expanded arrangement.

25. The method of claim 24, further comprising packing in a standardized shipping container the plurality of panel assemblies in the stacked arrangement.

26. The method of claim 24 wherein unfolding the panel assembly comprises pulling a deployment line coupled to the panel assembly.

27. The method of claim 24, further comprising coupling the plurality of the panel assemblies in the expanded arrangement to one another.
